(19) United States
(12) Patent Application Publication
(10) Pub. No.: US 2010/0061926 A1
(43) Pub. Date: Mar. 11, 2010

(54) HEATING SYSTEMS FOR HYDROGEN STORAGE MATERIALS

(75) Inventors: TERRY A. JOHNSON, LIVERMORE, CA (US); DANIEL E. DEDRICK, OAKLAND, CA (US); MICHAEL P. KANOUFF, LIVERMORE, CA (US)

Correspondence Address: General Motors Corporation;c/o REISING, ETHINGTON, BARNES, KISSELLE, P.C., P.O. BOX 4390, TROY, MI, 48099-4390, US

(73) Assignee: GM GLOBAL TECHNOLOGY OPERATIONS, INC., DETROIT, MI (US)

(21) Appl. No.: 12/547,065

(22) Filed: Aug. 25, 2009

Related U.S. Application Data
(60) Provisional application No. 61/096,019, filed on Sep. 11, 2008.

(51) Int. Cl. C01B 3/02; B01J 19/00

(52) U.S. Cl. 423/648.1; 422/198

(57) ABSTRACT

Auxiliary heating systems that can supply heat to a hydrogen storage material, which may comprise at least one hydridable material, located inside a hydrogen storage tank have been developed. These auxiliary heating systems involve the catalytic combustion of hydrogen and oxygen in a catalytic heater to produce heat and combustion products. The heat produced from the catalytic combustion may then be transferred, either indirectly or directly, to the hydrogen storage material to stimulate the release of additional desorbable hydrogen that may be stored in the at least one hydrdidable material.

### CROSS-REFERENCES TO RELATED APPLICATIONS

This Application claims the benefit of U.S. Provisional Application No. 61/096,019 filed on Sep. 11, 2008.

### TECHNICAL FIELD

The technical field relates generally to hydrogen storage and delivery systems for a hydrogen-consuming device.

### BACKGROUND

The use of hydrogen as a possible fuel source for a hydrogen-consuming device, such as a vehicle, has prompted research into hydrogen storage and delivery technologies. One particular area of focus involves the desire to store useful amounts of hydrogen in a storage tank operating within a relatively modest temperature and pressure range. To try and accomplish such a feat, a significant amount of attention has been directed towards hydrogen storage materials that include hydridable materials capable of reversibly forming hydride compounds in the presence of hydrogen gas. These hydridable materials, of which there are many, are able to reversibly sorb and desorb gaseous hydrogen at close to ambient pressure and temperature conditions. The addition of such materials to a hydrogen storage tank's interior can thus noticeably increase its hydrogen storage capacity.

Bulk hydridable materials, however, when situated inside a storage tank, may require a significant heat input to help quickly desorb an appreciable amount hydrogen for delivery to the hydrogen-consuming device. This heat input requirement can raise a variety of issues. For example, with regards to a vehicle, the source of heat needed to cause and manage hydrogen desportion may have to be carried on-board without adding unnecessary weight and mechanical complexity to the vehicle.

One possible way to address the issue of an on-board heat source involves recycling the exhaust heat produced by the on-board fuel cell power plant such as, for example, heat produced at the cathodes of a proton exchange membrane fuel cell stack. But a mismatch in the amount and/or quality of heat produced from a fuel cell power plant's exhaust, which tends to be at a temperature of about 80° C. or less, and that needed to induce and maintain hydrogen desportion from various hydridable materials, which may be around temperatures of 100° C. and above, makes this option somewhat challenging. Another option includes the use of an electric heater, such as a resistive heater, that is powered by a portion of the fuel cell power plant's electrical output. But the trouble with this approach is that the electrical heater's efficiency is inherently bound by the overall efficiency of the fuel cell power plant.

As such, there is a need to develop improved products and methods for supplying heat to a hydrogen storage material contained in a hydrogen storage tank.

### SUMMARY OF EXEMPLARY EMBODIMENTS

One exemplary embodiment includes a method that comprises providing a hydrogen storage tank that encloses a hydrogen storage material comprising at least one hydridable material that comprises desorbable hydrogen. A first flow of hydrogen may be supplied from the hydrogen storage tank. At least a portion of the first flow of hydrogen may be diverted to form a second flow of hydrogen. The second flow of hydrogen and a flow of oxygen may be delivered to a catalytic heater that comprises a catalyst that facilitates combustion of at least some of the second flow of hydrogen and the flow of oxygen to produce heat. At least some of the heat may be transferred to the hydrogen storage material to desorb at least some of the desorbable hydrogen from the at least one hydridable material.

Another exemplary embodiment includes a method that comprises providing a hydrogen storage tank constructed to supply a first flow of hydrogen to a hydrogen-consuming device and a second flow of hydrogen to a catalytic heater. The hydrogen storage tank may define a tank interior that comprises a hydrogen storage material comprising a complex metal hydride comprising desorbable hydrogen. The catalytic heater may comprise a catalyst that can facilitate combustion of hydrogen and oxygen. The second flow of hydrogen may be mixed with a flow of oxygen in the form of ambient air to form a reactant gas mixture. The reactant gas mixture may be delivered to the catalytic heater so that the reactant gas mixture interacts with the catalyst and at least partially combusts to produce heat. At least some of the heat may be transferred from the catalytic heater to the hydrogen storage material, either directly or indirectly, to desorb at least some of the desorbable hydrogen from the at least one complex metal hydride.

Yet another exemplary embodiment includes a system that comprises a hydrogen storage tank that encloses a hydrogen storage material comprising at least one hydridable material that comprises desorbable hydrogen, a hydrogen-consuming device that receives a first flow of hydrogen from the hydrogen storage tank, and a catalytic heater that receives a second flow of hydrogen from the hydrogen storage tank and a flow of oxygen. The catalytic heater may comprise a catalyst that facilitates combustion of the second flow of hydrogen and the flow of oxygen to produce heat. At least some of the heat produced by the combustion of the second flow of hydrogen and the flow of oxygen may be transferred to the hydrogen storage material to desorb at least some of the desorbable hydrogen from the at least one hydridable material.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings, wherein:

FIG. 1 is a schematic illustration of an auxiliary heating system for supplying heat to a hydrogen storage material in which indirect heating is utilized according to one embodiment of the invention.

FIG. 2 is an exploded perspective view of a catalytic heater that can indirectly supply heat to a hydrogen storage material according to one embodiment of the invention.

FIG. 3 is a magnified cutaway and isolated fragmentary view of a portion of a heat transfer layer of the reactor shown in FIG. 2.

FIG. 4 is a magnified cutaway and isolated fragmentary view of a portion of a heat transfer layer of the gas recuperator shown in FIG. 2.

FIG. 5 is a schematic illustration of an auxiliary heating system for supplying heat to a hydrogen storage material in which direct heating is utilized according to one embodiment of the invention.

FIG. 6 is a perspective view of a catalytic heater that can directly supply heat to a hydrogen storage system according to one embodiment of the invention.

FIG. 7 is a plot of data collected from the catalytic heater 16′ described in Example 1 showing the percent of hydrogen consumed as a function of the catalytic heater's 16′ percent of maximum operating power.

FIG. 8 is a plot of data collected from the catalytic heater 16′ described in Example 1 showing the total efficiency that is, the percentage of the combustion energy of the hydrogen transferred to the heat transfer fluid as a function of temperature and the total reactant gas flow rate.

FIG. 9 is a plot of data collected from the catalytic heater 16′ described in Example 1 showing the distribution of heat as a function of the catalytic heater's 16′ power level.

FIG. 10 is a plot of data collected from the catalytic heater 16′ described in Example 1 showing the efficiency of the catalytic heater 16′ at low temperatures during start-up.

FIG. 11 is a plot of data collected from the catalytic heater 16′ described in Example 1 showing the response time of the catalytic heater 16′ in which the flow rate of hydrogen gas and the inlet and outlet temperatures of the heat transfer fluids are plotted against time.

### DETAILED DESCRIPTION OF EXEMPLARY EMBODIMENTS

The following description of the embodiment(s) is merely exemplary in nature and is in no way intended to limit the invention, its application, or uses.

Several systems have been developed that can supply auxiliary heat to a hydrogen storage material that may be provided in a hydrogen gas storage tank. These auxiliary heating systems involve the catalytic combustion of hydrogen and oxygen in a catalytic heater to produce heat (about 242 kJ/mole H₂) and water vapor. The hydrogen may be supplied to the catalytic heater by diverting a small fraction of the hydrogen contained in the hydrogen storage tank. The oxygen may be supplied to the catalytic heater as air from the ambient environment or some other suitable source.

The heat generated from the catalytic combustion of hydrogen and oxygen may then be transferred to the hydrogen storage material either indirectly or directly to stimulate the release of more hydrogen gas. The term “indirect heating” and its grammatical variations are used here to indicate that heat generated from the catalytic combustion of hydrogen and oxygen is transferred to the hydrogen storage material by way of a circulating heat transfer fluid. Examples of suitable heat transfer fluids include, but are not limited to, water, a mineral oil, a synthetic oil, and combinations thereof. The term “direct heating” and its grammatical variations are used here to indicate that that heat generated from the catalytic combustion of hydrogen and oxygen is transferred directly to the hydrogen storage material without first being transferred to a heat transfer fluid.

These auxiliary heating systems provide a mass, volume, and energy efficient heat source for hydrogen storage materials that may require significant heat inputs to help desorb and deliver hydrogen gas. The energy efficiency of these auxiliary heating techniques, which may approach 100% in converting hydrogen gas to heat energy, can improve the overall fuel efficiency of a hydrogen-consuming device by reducing the energy load required to deliver hydrogen from a hydrogen storage tank.

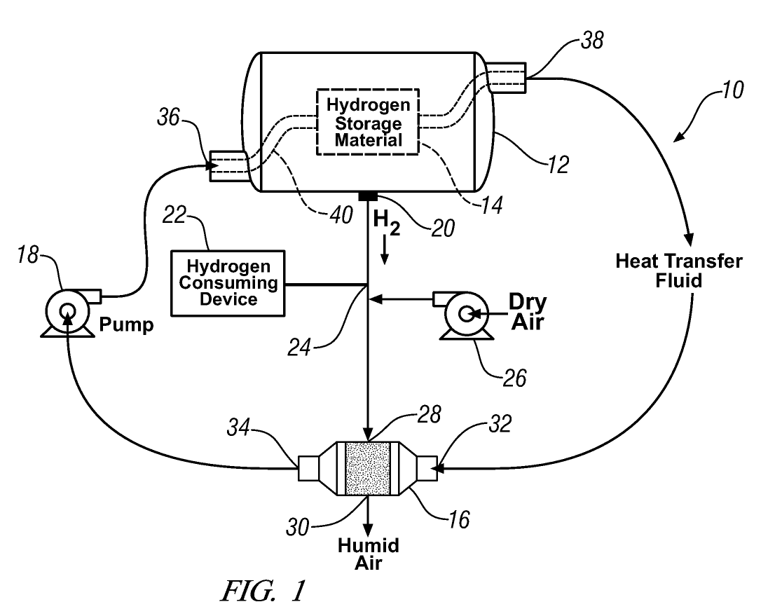

Referring now to FIG. 1, according to one embodiment, there is shown a schematic flow diagram of an auxiliary heating system 10 for indirectly heating a hydrogen storage material 14. The system 10 may include a hydrogen storage tank 12 that encloses the hydrogen storage material 14, a catalytic heater 16 in which hydrogen and oxygen catalytically combust to generate heat, and a circulation pump 18 or other similar mechanism for moving the heat transfer fluid between the catalytic heater 16 and the hydrogen storage tank 12 at an appropriate flow rate.

During operation of the auxiliary heating system 10, a hydrogen outlet port 20 releases hydrogen from the hydrogen storage tank 12 for delivery to a fuel-consuming device 22. A portion of the hydrogen released from the outlet port 20 may then be diverted at a diversion point 24 and mixed with oxygen in the form of air supplied from the external ambient environment by a blower or fan 26.

The reactant gas mixture of hydrogen and oxygen may then be delivered to the catalytic heater 16 at a reactant gas inlet 28. Once introduced to the catalytic heater 16, at least a portion the reactant gas mixture of hydrogen and oxygen catalytically combusts to produce combustion products and heat. The combustion products, which are comprised mainly of water vapor carried by oxygen-depleted air, may be expelled from the catalytic heater 16 through a combustion products outlet 30. The generated heat, however, may be transferred to the heat transfer fluid as it moves through the catalytic heater 16 from a heat transfer fluid inlet 32 to a heat transfer fluid outlet 34.

The heat transfer fluid may then be delivered to a heat transfer fluid inlet port 36 on the hydrogen storage tank 12. The heat transfer fluid inlet port 36 may be in fluid communication with a conduit 40 (shown in phantom) passing through the interior of the hydrogen storage tank 12 and in contact with, or in the vicinity of, the hydrogen storage material 14 so that heat can adequately and efficiently be transferred from the heat transfer fluid to the hydrogen storage material 14. After heating the hydrogen storage material 14, the heat transfer fluid may exit the hydrogen storage tank 12 through a heat transfer fluid outlet port 38 that is also in fluid communication with the conduit 40. The heat transfer fluid may then be circulated back towards the heat transfer fluid inlet 32 on the catalytic heater 16 to be re-heated. The flow of heat transfer fluid throughout the auxiliary heating system 10, as previously mentioned, may be accomplished by the circulation pump 18.

The hydrogen storage tank 12 may be of any known construction suitable for storing and delivering hydrogen gas. In some instances, the hydrogen storage tank 12 may be capable of storing hydrogen gas at temperatures and pressures that generally range from about −80° C. to about 300° C. and about 10 bar to about 875 bar, respectively.

The hydrogen storage material 14 contained inside the hydrogen storage tank 12 may comprise at least one hydridable material capable of reversibly sorbing and desorbing hydrogen gas. Such an attribute of the hydrogen storage material 14 allows the hydrogen storage tank 12 to achieve a greater gravimetric and volumetric energy density since the at least one hydridable material can store useful quantities of desorbable hydrogen therein without reducing the tank's 12 available free volume where freely gaseous and immediately dischargeable hydrogen is contained. The hydridable material may, in one embodiment, be a complex metal hydride that releases hydrogen gas most profusely when exposed to temperatures greater than that normally obtainable from a PEM fuel cell stack. Exemplary complex metal hydrides include, but are not limited to, the various known alanates, borohydrides, and amides that may require temperatures as high as 200° C. to release useable amounts of hydrogen gas. Some specific complex metal hydrides include sodium alanate (NaAlH₄), lithium alanate (LiAlH₄), lithium borohydride (LiBH₄) with or without MgH₂, calcium borohydride (CaBH₄) with or without MgH₂, and lithium amide (LiNH₂). There are, of course, dozens of other complex metal hydrides and other hydridable materials that have been reported in the literature and may be included in the hydrogen storage material 14. Other materials may also be included in the hydrogen storage material 14 along with the at least one hydridable material, if desired. An example of such a material is an absorbent that can help remove impurities from hydrogen gas.

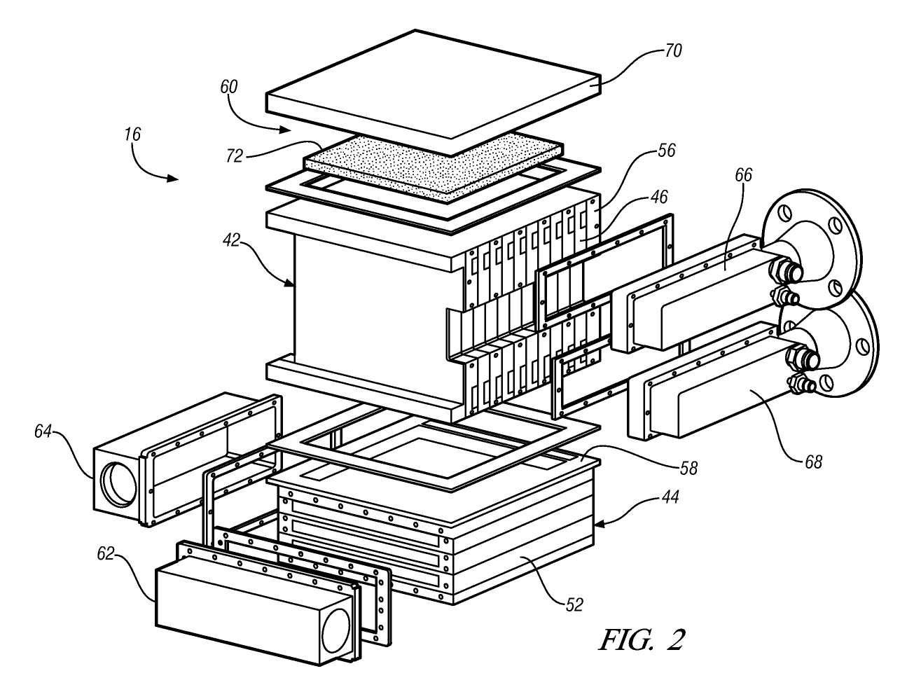

The catalytic heater 16, an embodiment of which is shown in FIG. 2, may include a reactor 42 configured to catalytically combust the reactant gas mixture of hydrogen and oxygen. The reactor 42 may also be configured to simultaneously transfer the heat generated from the catalytic combustion reaction to the heat transfer fluid. In other words, the reactor 42 may operate as both a catalytic reactor and a heat exchanger. The catalytic heater 16 may also include a gas recuperator 44 constructed to heat the reactant gas mixture, prior to entering the reactor 42, with the relatively hot combustion products leaving the reactor 42. This pre-heating can help facilitate a more energy efficient catalytic combustion reaction in the reactor 42 since the rate of reaction for such a hydrogen oxidation reaction increases with temperature. A specific and exemplary embodiment of a prototype catalytic heater 16′ is described along with some performance data in EXAMPLE 1.

The reactor 42 may include one or more heat transfer cells or layers 46 each constructed to simultaneously receive both a flow of the reactant gas mixture and a flow of the heat transfer fluid. The heat transfer layer 46 may be constructed from a highly thermally conductive and corrosion resistant material such as, but not limited to, aluminum, copper, silver, and their various alloys. In one embodiment, as best shown in FIG. 3, the heat transfer layer 46 may include a gas-flow channel 46A and a liquid-flow channel 46B. The gas-flow channel 46A may communicate the reactant gas mixture and facilitate the catalytic combustion of hydrogen and oxygen, and the liquid-flow channel 46B may communicate the heat transfer fluid. The simultaneous flow of the combusting, heat-generating reactant gas mixture and the heat transfer fluid through their respective channels 46A, 46B in a very thermally active heat transfer layer 46 results in significant heat gains by heat transfer fluid as it proceeds along the liquid-flow channel 46B.

The gas-flow channel 46A may include catalyst-containing fins 48 to help promote the combustion of hydrogen and oxygen in the reactant gas mixture and to provide an increased surface area for heat transfer to occur. The fins 48 may, as shown, be rectangular in shape. But of course other shapes such as diagonal fins, circular fins, or even fins that resemble bumps or protrusions may be employed. The catalyst carried by the fins 48 may be any appropriate catalyst known to skilled artisans. Exemplary catalysts include platinum and palladium. But other lower cost catalysts may also be used if their reactivity is deemed sufficient. The catalyst or catalysts may be applied to the surface of the fins 48 in a variety of manners. For example, in one embodiment, a pure thin catalyst film coating may be deposited by a process such as chemical vapor deposition, plasma vapor deposition, or electrodeposition. In another embodiment, the catalyst or catalysts may be applied in the form of a carbon-supported catalyst matrix in which catalyst particles are suspended in a carbon carrier powder. The carbon-supported catalyst matrix may be applied to the surface of the fins 48 by way of an adhesive material such as an epoxy or adhesive paint. But however applied, it may be useful to vary the catalyst concentration along the gas-flow channel 46A of one or more of the heat transfer layers 48 to help control and/or achieve the amount of heat produced by the combustion reaction as is generally understood by skilled artisans.

The liquid-flow channel 46B may include fins 50 similar to those in the gas-flow channel 46A to provide an increased surface area for more efficient heat transfer. The fins 50 may, for example, be rectangular in shape as shown or embody the other fin shapes previously mentioned. The surface of the fins 50, however, does not have to contain a catalyst since a combustion reaction is not taking place in the liquid-flow channel 46B. The fins 50 may also be spaced closer together and have a higher density along the width W of the fluid-flow channel 46B when compared to the fins 48 in the gas-flow channel 46A.

The gas-flow channel 46A and the liquid-flow channel 46B of the heat transfer layer 46 may be oriented so that the reactant gas mixture and the heat transfer fluid flow concurrently (in the same direction) through the layer 46. This flow arrangement may be useful because, first, the heat produced from the catalytic combustion of the reactant gas mixture is largest when initially introduced into the heat transfer layer 46 and, second, the temperature of the heat transfer fluid is lowest when initially introduced into the heat transfer layer 46. The concurrent flow arrangement therefore results in a maximum heat flux between the combusting reactant gas mixture and the heat transfer fluid at the end of the heat transfer layer 46 where both of the reactant gas mixture and the heat transfer fluid commonly enter their respective channels 46A, 46B. This high initial heat flux experienced in the heat transfer layer 46 helps maximize the quantity of heat transferred to the heat transfer fluid while minimizing the overall temperature in the reactor 42. Other flow arrangements in the heat transfer layer 46, however, such as counter flow and cross flow are possible and can easily be employed in the reactor 42 if desired.

In one embodiment, and referring back to FIG. 2, the reactor 42 may comprise a plurality of the heat transfer layers 46 just described. The heat transfer layers 46 may be brazed or otherwise bonded together so that the reactor 42 comprises alternating gas-flow and liquid-flow channels 46A, 46B to help maximize the overall heat transfer from the combusting reactant gas mixture to the heat transfer fluid within the reactor 42.

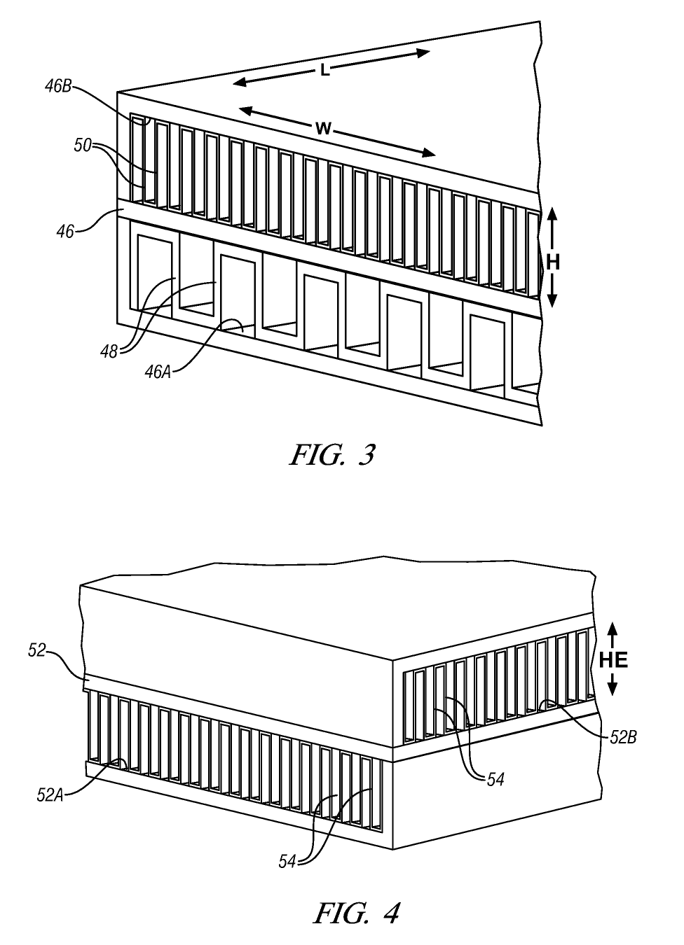

The gas recuperator 44, as previously mentioned, may be used to pre-heat the reactant gas mixture before it enters the reactor 42. In one embodiment, as best shown in FIG. 4, the gas recuperator 44 may comprise one or more heat transfer cells or layers 52 having an inlet gas-flow channel 52A and an outlet gas-flow channel 52B. The inlet gas-flow channel 52A may communicate the reactant gas mixture to the reactor 42 and the outlet gas-flow channel 52B may communicate the combustion products from the reactor 42. Similar to the heat transfer layer 46 employed in the reactor 42, this heat transfer layer 52 may also be constructed from a highly thermally conductive and corrosion resistant material such as, but not limited to, aluminum, copper, silver, and their various alloys.

Both of the inlet gas-flow channel 52A and the outlet gas-flow channel 52B may include fins 54 to increase the surface area where heat transfer can occur. The size and shape of the fins 54 located in the inlet gas-flow channel 52A and the outlet gas-flow channel 52B may generally be the same, although similarity of the fins 54 in the two channels 52A, 52B is not mandatory. Additionally, as shown, the inlet gas-flow channel 52A and the outlet gas-flow channel 52B may be oriented perpendicular to one another to establish a cross flow arrangement. Other flow arrangements, however, may be utilized in the gas recuperator 44.

In one embodiment, and referring back to FIG. 2, the gas recuperator 44 may comprise a plurality of the heat transfer layers 52 just described. The heat transfer layers 52 may be brazed or otherwise bonded together so that the gas recuperator 44 comprises alternating inlet gas-flow and outlet gas-flow channels 52A, 52B to help maximize the overall heat transfer from the combustion products to the reactant gas mixture within the gas recuperator 44.

The catalytic heater 16 may also include other conventional components such as a reactant gas deflection cap 56, a combustion products deflection cap 58, a gas flow diffuser 60, an inlet gas manifold 62, an outlet gas manifold 64, an inlet heat transfer fluid passage 66, and an outlet heat transfer fluid passage 68, all of which are shown in FIG. 2, and other components or parts that are not shown such as flow control equipment and casings, to name but a few.

The reactant gas deflection cap 56 may be in fluid communication with the inlet gas-flow channels 52A of the gas recuperator 44 and the gas flow diffuser 60 and, if desired, mounted on the reactor 42 as shown. One function of the reactant gas deflection cap 56 may be to deliver the reactant gas mixture, upon exiting the gas recuperator 44, to the gas flow diffuser 60. The combustion products deflection cap 58 may be in fluid communication with the gas-flow channels 46A of the one or more heat transfer layers 46 of the reactor 42 and the outlet gas flow channels 52B of the one or more heat transfer layers 52 of the gas recuperator 44. One function of the combustion products deflection cap 58 may be to deliver the combustion products, upon exiting the reactor 42, to the gas recuperator 44.

The gas flow diffuser 60 may comprise a cover 70 and a gas diffusion sheet 72. The cover 70 may be formed from a gas-impermeable material and constructed to contain the incoming reactant gas mixture. The gas diffusion sheet 72 may be of any known variety capable of evenly and uniformly distributing the reactant gas mixture to the gas-flow channels 46A in the one or more heat transfer layers 46 of the reactor 42. The flow of the reactant gas mixture through the gas diffusion sheet 72 may be driven at least in part by the gas pressure build-up in the volume enclosed by the cover 70.

The inlet gas manifold 62, which introduces the reactant gas mixture to the inlet gas-flow channels 52A of the one or more heat transfer layers 52 of the gas recuperator 44, and the outlet gas manifold 64, which receives the combustion products from the outlet gas-flow channels 52B of the one or more heat transfer layers 52 of the gas recuperator 44, are conventional in nature and may be secured to the gas recuperator 44 with gaskets and screws. Similarly, the inlet heat transfer fluid passage 66 and the outlet heat transfer fluid passage 68, which communicate the heat transfer fluid to and from the fluid-flow channels 46B of the one or more heat transfer layers 46 of the reactor 42, may also be conventional in nature and secured to the reactor 42 with gaskets and screws.

The catalytic heater 16 may be controlled by known control equipment to produce a desired quantity of heat as well as ensuring high efficiency by combusting as much hydrogen as possible. For instance, the efficiency of the catalytic heater 16 and the total amount of heat it produces can be controlled by properly adjusting the total hydrogen flow rate to the catalytic heater 16, the ratio of hydrogen to oxygen in the reactant gas mixture that enters the catalytic heater 16, the catalyst formulation and/or concentration in the catalytic heater 16, and the temperature of the reactant gas mixture that enters the catalytic heater 16. Skilled artisans will know and understand how to control these and other process parameters, as well as the types of control equipment that may be used, such that a more complete discussion on this issue need not be provided here.

When the catalytic reactor 16 is utilized in the auxiliary heating system 10 shown in FIG. 1, a flow of the reactant gas mixture of hydrogen and air (from the diversion point 24 and blower 26) may be received in the inlet gas manifold 62 (generally and schematically represented in FIG. 1 as the reactant gas inlet 28) and directed into the gas recuperator 44. There, the reactant gas mixture may enter the inlet gas-flow channels 52A on one side of the one or more heat transfer layers 52 while hot combustion products are flowing perpendicularly through the outlet gas-flow channels 52B on the opposite side of the one or more layers 52. The reactant gas mixture captures a significant amount of heat from the flow of combustion products as it moves along the inlet gas-flow channels 52A and towards the opposite end of the gas recuperator 44.

Upon exiting the inlet gas-flow channels 52A, the reaction gas mixture may enter the gas deflection cap 56 where it gets carried up along the back of the reactor 42 and towards the gas flow diffuser 60. The cover 70 and the gas diffusion sheet 72 of the gas flow diffuser 60 may then distribute the reaction gas mixture to the reactor 42.

At this point, after emerging from the gas flow diffuser 60, the reactant gas mixture may flow evenly and uniformly into the gas-flow channels 46A of the one or more heat transfer layers 46 of the reactor 42. The catalyst-containing fins 48 located in and along the gas-flow channels 46A may help promote the combustion of hydrogen and oxygen in the reactant gas mixture to produce heat and combustion products. At the same time, while the reactant gas mixture is flowing along the gas-flow channels 46A and combusting, the inlet heat transfer fluid passage 66 (generally and schematically represented in FIG. 1 as the heat transfer fluid inlet 32) may be introducing the heat transfer fluid into the fluid-flow channels 46B of the one or more heat transfer layers 46 of the reactor 42. The heat transfer fluid may flow concurrently to the flow of the reactant gas mixture. The heat transfer fluid may, through the highly thermally conductive heat transfer layers 46, extract significant quantities of the generated heat before exiting the fluid-flow channels 46B at the outlet heat transfer fluid passage 68 (generally and schematically represented in FIG. 1 as the heat transfer fluid outlet 34). From there, the heat transfer fluid may be circulated to the hydrogen storage tank 12 to supply heat to the hydrogen storage material 12 and then returned to the catalytic heater 16. The combustion products, which may contain water vapor and possibly some excess hydrogen and air, may exit the gas-flow channels 46A as a relatively hot and more-humid gas flow.

After leaving the gas-flow channels 46A of the one or more heat transfer layers 46, the combustion products may flow through the combustion products deflection cap 58 and into the outlet gas flow channels 52B of the one or more heat transfer layers 52 of the gas recuperator 44. The combustion products may, as previously stated, preheat an incoming cross-flow of the reactant gas mixture while flowing along the outlet gas flow channels 52B towards the outlet gas manifold 64 (generally and schematically represented in FIG. 1 as the combustion products outlet 30). When received in the outlet gas manifold 64, the combustion products may be expelled to the environment as a waste stream or recycled elsewhere.

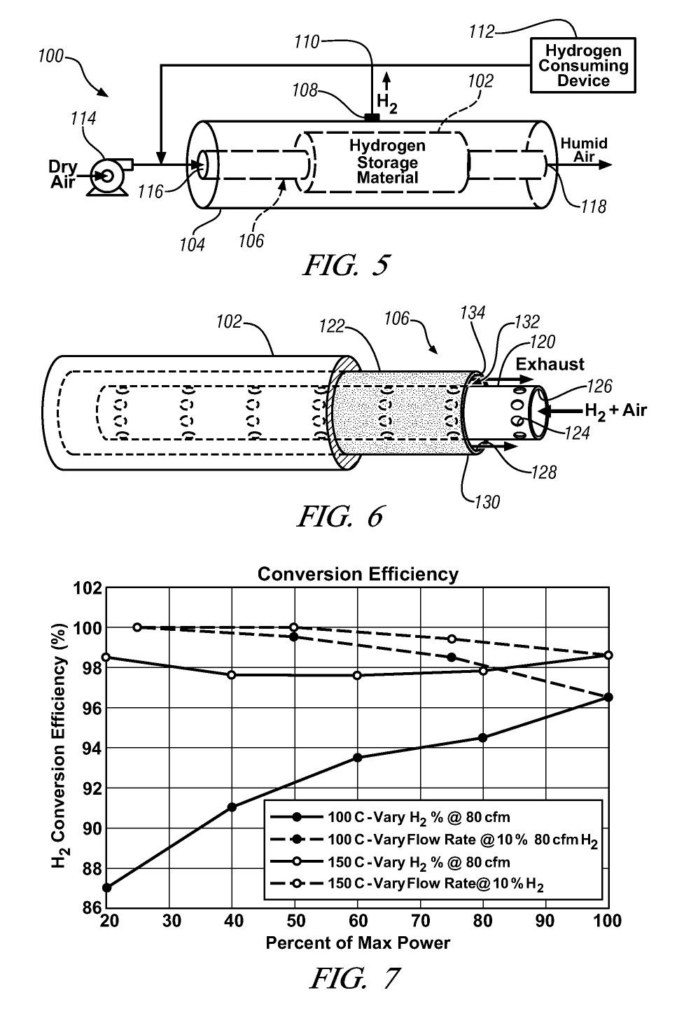

Referring now to FIG. 5, according to another embodiment, there is shown a schematic flow diagram of an auxiliary heating system 100 for directly heating a hydrogen storage material 102. The system 100 may include a hydrogen storage tank 104 that encloses both the hydrogen storage material 102 and a catalytic heater 106 in which hydrogen and oxygen catalytically combust to generate heat. The catalytic heater 106 may directly contact the hydrogen storage material 102 or be in very close proximity to the hydrogen storage material 102. This close spatial arrangement allows the catalytic heater 106 to transfer heat directly to the hydrogen storage material 102 in an efficient manner without the use of a circulating heat transfer fluid.

During operation of the auxiliary heating system 100, a hydrogen outlet port 108 releases hydrogen from the hydrogen storage tank 104 for delivery to a hydrogen-consuming device 112. A portion of the hydrogen released from the outlet port 108 may then be diverted at a diversion point 110 and mixed with oxygen in the form of air supplied from the external ambient environment by a blower or fan 114.

The reactant gas mixture of hydrogen and oxygen may then be fed to the catalytic heater 106 at a reactant gas inlet 116. Once introduced to the catalytic heater 106, at least a portion the reactant gas mixture of hydrogen and oxygen catalytically combusts to produce combustion products and heat. The combustion products, which are comprised mainly of water vapor carried by oxygen-depleted air, may be expelled from the catalytic heater 106 through a combustion products outlet 118. The generated heat may be transferred from the catalytic heater 106 to the closely situated hydrogen storage material 102.

The hydrogen storage tank 104 may be of any known construction suitable for storing and delivering hydrogen gas, much like the hydrogen storage tank 12 utilized in the auxiliary heating system 10 previously described. The hydrogen storage material 102 contained inside the hydrogen storage tank 104 may also be the same as the hydrogen storage material 14 described earlier when discussing the auxiliary heating system 10.

In some instances, however, it may be more feasible for the hydrogen storage tank 104 of this auxiliary heating system 100 to have an elongated cylindrical shape. A hydrogen storage tank 104 possessing such a shape may better accommodate the catalytic heater 106, as will be described below. Moreover, if the hydrogen storage tank 104 is cylindrical in shape, a plurality of similar hydrogen storage tanks 104 may be used together to provide additional hydrogen storage capacity if needed.

The catalytic heater 106, an embodiment of which is shown in FIG. 6, may include a gas distribution member 120 and a catalyst-containing shell 122 that are configured to catalytically combust the reactant gas mixture of hydrogen and oxygen. The heater 106 may also be configured to simultaneously transfer the heat generated from the catalytic combustion reaction to the surrounding and contacting hydrogen storage material 102. In other words, the catalytic heater 106 may operate as both a catalytic reactor and a heat exchanger.

The gas distribution member 120 may be an elongated hollow tube that includes a substantially uniform distribution of perforated holes 124 along its axial length. The gas distribution member 120 may also have a reactant gas inlet 126 at one end and be closed or plugged at the opposite end. Such a construction evenly disperses the reactant gas mixture from the gas distribution member 120 through the perforated holes 124 to help the catalytic heater 106 form and maintain a uniform heat flux. The gas distribution member 120 may be formed from any suitable material including, but not limited to, a high-temperature polymer such as a polyetheretherketone (PEEK), a polyamideimide (PAI), or a high temperature sulfone.

The catalyst-containing shell 122 may be a hollow elongated tube that accommodates the gas distribution member 120. The catalyst-containing shell 122 may have an inner surface 128 that carries the catalyst and an outer surface 130 that contacts or is closely proximate to the surrounding hydrogen storage material 102. Both the inner surface 128 and the outer surface 130 of the catalyst-containing shell 122 may be relatively smooth or include fins, bumps, or other protrusions that can manipulate the heat flow across and through the shell 122. The size and shape of the catalyst-containing shell 122 may be roughly complimentary to that the gas distribution member 120 while having a larger diameter so that an annulus 132 is formed between the inner surface 128 of the catalyst-containing shell 122 and the gas distribution member 120. Such an annulus 132 may provide the necessary space for the reactant gas mixture to interact with the catalyst carried on the inner surface 128 of the catalyst-containing shell 122 and ultimately combust to produce heat and combustion products. The catalyst-containing shell 122 may also include a combustion products outlet 134 at one end and be closed or plugged at the opposite end. To help promote effective heat transfer, the catalyst-containing shell 122 may be constructed from a highly thermally conductive and corrosion resistant material such as, but not limited to, aluminum, copper, silver, and their various alloys.

The catalyst carried by the inner surface 128 of the catalyst-containing shell 122 may be the same catalyst or catalysts and be applied in the same manner as previously described when discussing the auxiliary heating system 10. The catalyst may, in some embodiments, be applied to the inner surface 128 as strips or other discrete shapes at regular or irregular intervals to help control and maintain a substantially uniform heat distribution through the catalyst-containing shell 122 and avoid “hot spots.” The same effect may also be accomplished by varying the catalyst concentration along the inner surface 128 of the catalyst-containing shell 122 as understood by skilled artisans.

The catalytic heater 106 may be controlled by known control equipment to produce a desired quantity and distribution of heat as well as ensuring high efficiency by combusting as much hydrogen as possible. For instance, the efficiency of the catalytic heater 106, the total amount of heat the catalytic heater 106 produces, and the distribution of heat to the hydrogen storage material 102 through the catalyst-containing shell 122 can each be controlled by properly adjusting at least one of several process parameters. Some process parameters that may be controlled include the total hydrogen flow rate to the catalytic heater 106, the ratio of hydrogen to oxygen in the reactant gas mixture that enters the catalytic heater 106, the catalyst formulation and/or concentration in the catalytic heater 106, and the temperature of the reactant gas mixture that enters the catalytic heater 106. Skilled artisans will know and understand how to control these and other process parameters, as well as the types of control equipment that may be used, such that a more complete discussion on this issue need not be provided here.

When the catalytic reactor 106 is utilized in the auxiliary heating system 100 shown in FIG. 5, a flow of the reactant gas mixture of hydrogen and air (from diversion point 110 and blower 114) may be received in gas distribution member 120 through the reactant gas inlet 126 (generally and schematically represented in FIG. 5 as the reactant gas inlet 116). There, the reactant gas mixture may fill the hollow gas distribution member 120 and diffuse uniformly into the annulus 132 through the perforated holes 124. Once inside the annulus 132, the hydrogen and oxygen contained in the reactant gas mixture interact with the catalyst on the inner surface 128 of the catalyst-containing shell 122 and begin combusting to produce heat and water vapor. The heat produced from the catalytic combustion of hydrogen and oxygen in the annulus 132 may then be transferred to the outer surface 130 of the catalyst-containing shell 122 and eventually to the hydrogen storage material 102 to stimulate the release of additional hydrogen.

The combustion products, which may contain water vapor and possibly some excess hydrogen and air, may flow towards the combustion products outlet 134 (generally and schematically represented in FIG. 5 as the combustion products outlet 118) as new reactant gas mixture is introduced to the annulus 132. The combustion products may then be expelled from the hydrogen storage tank 104 and released into the environment as a waste stream or recycled for use elsewhere.

### Example 1

### Catalytic Heater (Indirect Heat)

A specific embodiment of a catalytic heater 16′, denoted here with a prime number that corresponds to like numerals in FIGS. 1-3, has been developed that can transfer more than 30 KW of heat from the catalytic combustion of hydrogen and oxygen to a heat transfer fluid. The sizes, shapes, and configurations of a reactor 42′ and a gas recuperator 44′ have been adjusted and optimized in an effort to maximize heat transfer to the heat transfer fluid while minimizing the mass and volume of the catalytic heater 16′.

In this embodiment, the reactor 42′ comprises ten heat transfer layers 46′ similar to those shown and described in FIGS. 2-3. The ten layers 46′ were brazed together so that alternating and parallel gas-flow channels 46A′ and liquid-flow channels 46B′, which allow for concurrent flow, were formed. Each of the layers 46′ has a length L (along which the reactant gas mixture and the heat transfer fluid flow) of about five inches and a width W (perpendicular to the flow of the reactant gas mixture) of about eight inches. The catalyst-containing fins 48′ in the gas-flow channel 46A′ of each heat transfer layer 46′ have a height H of about 0.375 inches and a wall thickness of about 0.032 inches. The density of the catalyst-containing fins 48′ is roughly six fins per inch along the width W of each layer 46′. The fins 50′ located in the liquid-flow channel 46B′ of each heat transfer layer 46′, on the other hand, have the same height (about 0.375 inches) as the catalyst-containing fins 48′ but a thinner wall thickness of about 0.010 inches. Moreover, the density of the fins 50′ in the fluid-flow channels 46B′ is about 25 fins per inch along the width W of each layer 46′. Each of the heat transfer layers 46′—including the fins 48′, 50′ respectively located in the gas-flow channels 46A′ and the fluid-flow channel 46B′—was fabricated from aluminum and is commercially available from Robinson Fin Machines located in Kenton, Ohio.

The catalyst-containing fins 48′ were coated with a palladium catalyst after each of the ten heat transfer layers 46′ were brazed together. To coat the fins 48′ with the palladium catalyst, palladium particles were suspended on a carbon powder and mixed into a high-temperature paint. A solvent was then used to control the viscosity of the resultant mixture. The ten heat transfer layers 46′, with the fluid-flow channels 46B′ blocked, were then dip coated in the catalyst/paint mixture and baked to remove volatiles. A coating of carbon-supported palladium remained on the surfaces of the fins 48′ after baking.

The gas recuperator 44′ of this embodiment comprises three heat transfer layers 52′ similar to those shown and described in FIG. 4. The three heat transfer layers 52′ were brazed together so that alternating and perpendicular inlet gas-flow channels 52A′ and outlet gas flow channels 52B′, which impose a cross flow arrangement, were formed. Each of the heat transfer layers 52′ is about eight inches by eight inches in size. The fins 54′ located in the both the inlet gas flow channels 52A′ and the outlet gas flow channels 52B′ of each heat transfer layer 52′ have a height HE of about 0.375 inches and a wall thickness of about 0.010 inches. The density of the fins 54′ in both the inlet gas flow channels 52A′ and the outlet gas flow channels 52B′ is also the same—about 25 fins per inch. Much like the reactor 42′, each of the heat transfer layers 52′ may be formed from aluminum and obtained from Robinson Fin Machines.

The catalytic heater 16′ was operated and subjected to varying operating conditions for data collection purposes. FIG. 7 shows, for instance, the percent of hydrogen consumed as a function of the catalytic heater's 16′ percent of maximum operating power. The data in FIG. 7 demonstrates that a high percentage, close to 100%, of the hydrogen fed to the reactor 42′ can be converted to thermal energy at operating temperatures of both 100° C. and 150° C. and variable hydrogen flow rates.

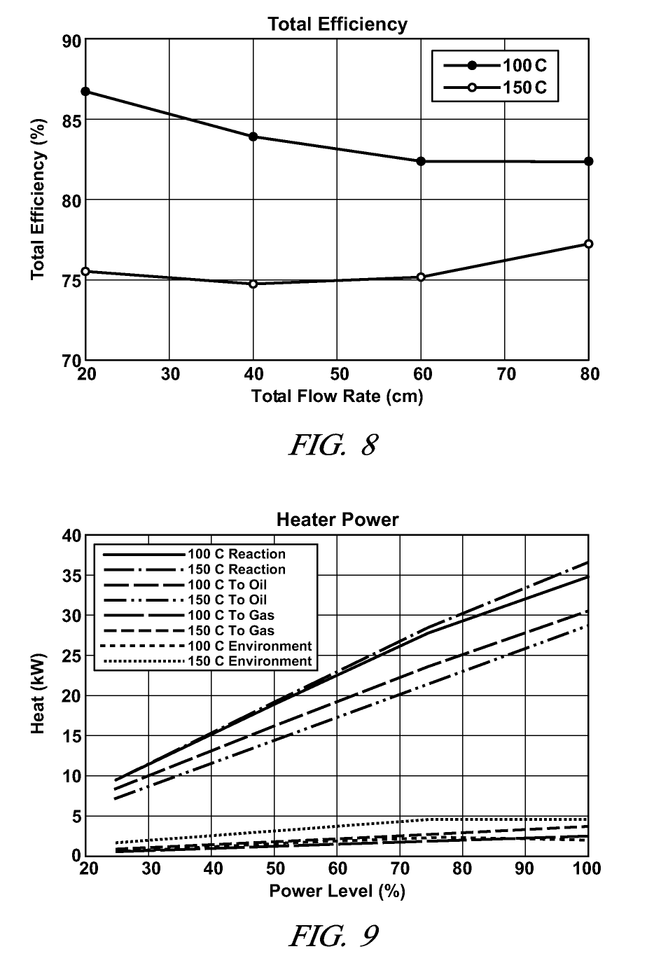

FIG. 8 shows the total efficiency of the reactor 42′—that is, the percentage of the combustion energy of the hydrogen transferred to the heat transfer fluid—as a function of temperature and the total reactant gas flow rate. The data in FIG. 8 reveals that over 75% of the thermal energy produced by the catalytic combustion of hydrogen and oxygen in the reactor 42′ was transferred to the heat transfer fluid.

FIG. 9 shows the distribution of heat as a function of the catalytic heater's 16′ power level. The data in FIG. 9 reveals that, at 100% operating power, the reactor 42′ transfered about 30 kW and about 28 kW of thermal energy to the heat transfer fluid at 100° C. and 150° C., respectively.

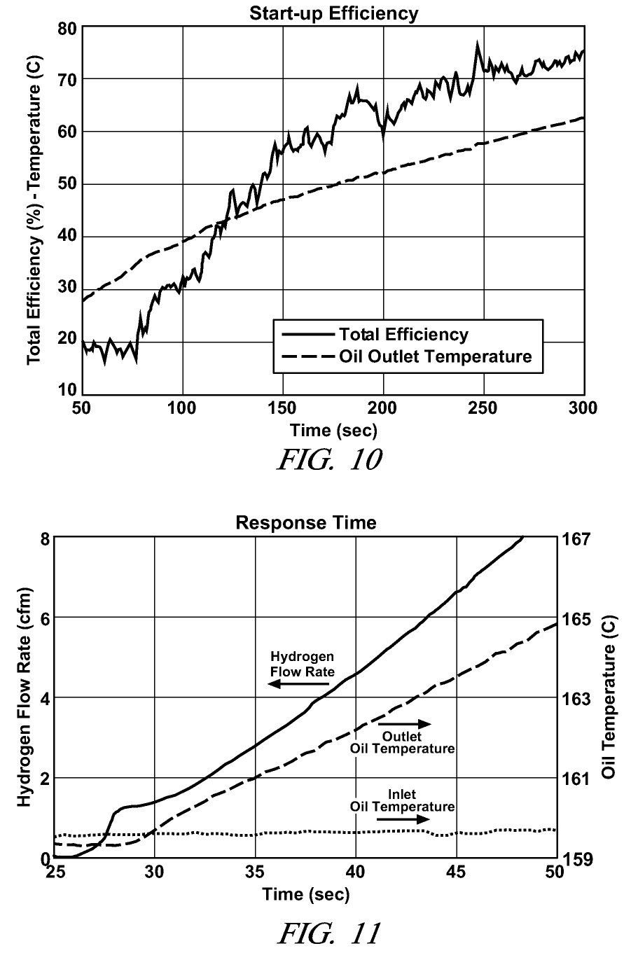

FIG. 10 shows the efficiency of the catalytic heater 16′ at low temperatures during start-up. Here, in FIG. 10, the catalytic heater 16′ was turned on at 50 seconds and an initial efficiency of about 20% was observed. The efficiency of the catalytic heater 16′, however, increased to over 70% by the time the heat transfer fluid outlet temperature reached about 60° C., which occurred around 275 seconds.

FIG. 11 shows the response time of the catalytic heater 16′ in which the flow rate of hydrogen gas and the inlet and outlet temperatures of the heat transfer fluids are plotted against time. The data in FIG. 11 reveals that the heat transfer fluid outlet temperature began to increase within a few seconds of the start of hydrogen flow to the reactor 42′.

Moreover, although not shown in a data plot, the use of the gas recuperator 44′ to pre-heat the reactant gas mixture entering the reactor 42′ resulted in an efficiency gain of about 20-25% in the reactor 42′ when the recuperator 44′ was operated at 150° C.

The above description of various embodiments of the invention is merely exemplary in nature and is not intended to limit the scope of the invention, its application, or its uses.

What is claimed is:

1. A method comprising:
providing a hydrogen storage tank that encloses a hydrogen storage material comprising at least one hydridable material that comprises desorbable hydrogen;
supplying a first flow of hydrogen from the hydrogen storage tank;
diverting at least a portion of the first flow of hydrogen to form a second flow of hydrogen;
delivering the second flow of hydrogen and a flow of oxygen to a catalytic heater that comprises a catalyst that facilitates combustion of at least some of the second flow of hydrogen and the flow of oxygen to produce heat;
transferring at least some of the heat to the hydrogen storage material to desorb at least some of the desorbable hydrogen from the at least one hydridable material.

2. The method of claim 1, further comprising mixing the second flow of hydrogen and the flow of oxygen into a reactant gas mixture before delivering the second flow of hydrogen and the flow of oxygen to the catalytic heater.

3. The method of claim 2, wherein delivering the reactant gas mixture to a catalytic heater comprises delivering the reactant gas mixture to a catalytic heater that comprises a gas recuperator and a reactor, the gas recuperator being constructed and arranged to preheat the reactant gas mixture before the reactant gas mixture enters the reactor, the reactor comprising the catalyst and being constructed and arranged to communicate and combust the reactant gas mixture and to further communicate a heat transfer fluid such that at least some of the heat is transferred to the heat transfer fluid.

4. The method of claim 3, wherein delivering the reactant gas mixture to a catalytic heater comprises delivering the reactant gas mixture to a catalytic heater that comprises a reactor comprising one or more heat transfer layers comprising a gas-flow channel for communicating and combusting the reactant gas mixture and a liquid-flow channel for communicating the heat transfer fluid, the gas-flow channel comprising fins that comprise the catalyst.

5. The method of claim 3, wherein delivering the reactant gas mixture to a catalytic heater comprises delivering the reactant gas mixture to a catalytic heater that comprises a gas recuperator comprising one or more heat transfer layers comprising an inlet-gas flow channel for communicating the reactant gas mixture and an outlet-gas flow channel for communicating combustion products from the reactor.

6. The method of claim 3, wherein transferring at least some of the heat to the hydrogen storage material comprises indirectly transferring at least some of the heat to the hydrogen storage material by circulating the heat transfer fluid between the catalytic reactor and the hydrogen storage tank.

7. The method of claim 2, wherein delivering the reactant gas mixture to a catalytic heater comprises delivering the reactant gas mixture to a catalytic heater located in the hydrogen storage tank that contacts or is in close proximity to the hydrogen storage material.

8. The method of claim 7, wherein delivering the reactant gas mixture to a catalytic heater comprises delivering the reactant gas mixture to a catalytic heater comprising a gas distribution member and a catalyst-containing shell, the gas distribution member comprising perforated holes and the catalyst-containing shell comprising an inner surface that comprises the catalyst and an outer surface, the catalyst-containing shell accommodating the gas distribution member so that an annulus is formed between the gas diffusion member and the inner surface of the catalyst-containing shell for communicating and combusting the reactant gas mixture to produce the heat.

9. The method of claim 7, wherein delivering the reactant gas mixture to a catalytic heater comprises delivering the reactant gas mixture to a catalytic heater comprising a gas distribution member comprising an elongated hollow tube that includes a substantially uniform distribution of the perforated holes along an axial length of the elongated hollow tube to evenly disperse the reactant gas mixture into the annulus.

10. The method of claim 7, wherein transferring at least some of the heat to the hydrogen storage material comprises directly transferring at least some of the heat from the outer surface of the catalyst-containing shell to the hydrogen storage material.

11. The method of claim 1, wherein providing a hydrogen storage tank comprises providing a hydrogen storage tank that encloses a hydrogen storage material comprising at least one complex metal hydride.

12. The method of claim 11, wherein providing a hydrogen storage material comprises providing a hydrogen storage material comprising at least one of an alanate, a borohydride, or an amide

13. The method of claim 11, wherein providing a hydrogen storage material comprises providing a hydrogen storage material comprising at least one of NaAlH₄, LiAlH₄, LiBH₄, CaBH₄, or LiNH₂.

14. A method comprising:
providing a hydrogen storage tank constructed to supply a first flow of hydrogen to a hydrogen-consuming device and a second flow of hydrogen to a catalytic heater, the hydrogen storage tank defining a tank interior that comprises a hydrogen storage material comprising a complex metal hydride comprising desorbable hydrogen, the catalytic heater comprising a catalyst that can facilitate combustion of hydrogen and oxygen;
mixing the second flow of hydrogen with a flow of oxygen in the form of ambient air to form a reactant gas mixture;
delivering the reactant gas mixture to the catalytic heater so that the reactant gas mixture interacts with the catalyst and at least partially combusts to produce heat;
transferring at least some of the heat from the catalytic heater, either directly to the hydrogen storage material or indirectly to the hydrogen storage material by way of a heat transfer fluid that circulates between the hydrogen storage tank and the catalytic heater, to desorb at least some of the desorbable hydrogen from the at least one complex metal hydride.

15. The method of claim 14, wherein delivering the reactant gas mixture to the catalytic heater comprises delivering the reactant gas mixture to a gas recuperator and a reactor, the gas recuperator being constructed and arranged to preheat the reactant gas mixture before the reactant gas mixture enters the reactor, the reactor comprising the catalyst and being constructed and arranged to communicate and combust the reactant gas mixture to produce the heat and combustion products and to further communicate a heat transfer fluid such that at least some of the heat is transferred to the heat transfer fluid, and wherein transferring at least some of the heat to the hydrogen storage material comprises indirectly transferring at least some of the heat to the hydrogen storage material by circulating the heat transfer fluid between the catalytic reactor and the hydrogen storage tank.

16. The method of claim 15, wherein delivering the reactant gas mixture to the catalytic heater comprises delivering the reactant gas mixture to a gas recuperator comprising one or more heat transfer layers comprising an inlet-gas flow channel for communicating the reactant gas mixture and an outlet-gas flow channel for communicating the combustion products from the reactor, and a reactor comprising one or more heat transfer layers comprising a gas-flow channel for communicating and combusting the reactant gas mixture and a liquid-flow channel for communicating the heat transfer fluid, the gas-flow channel comprising fins that comprise the catalyst.

17. The method of claim 14, wherein delivering the reactant gas mixture to the catalytic heater comprises delivering the reactant gas mixture to the catalytic heater within the tank interior of the hydrogen storage tank such that the catalytic heater is in contact with or in close proximity to the hydrogen storage material, the catalytic heater comprising a gas distribution member and a catalyst-containing shell, the gas distribution member comprising perforated holes and the catalyst-containing shell comprising an inner surface that comprises the catalyst and an outer surface, the catalyst-containing shell accommodating the gas distribution member so that an annulus is formed between the gas distribution member and the inner surface of the catalyst-containing shell for communicating and combusting the reactant gas mixture, and wherein transferring at least some of the heat to the hydrogen storage material comprises directly transferring at least some of the heat from the outer surface of the catalyst-containing shell to the hydrogen storage material.

18. A system comprising:
a hydrogen storage tank that encloses a hydrogen storage material comprising at least one hydridable material that comprises desorbable hydrogen;
a hydrogen-consuming device that receives a first flow of hydrogen from the hydrogen storage tank;
a catalytic heater that receives a second flow of hydrogen from the hydrogen storage tank and a flow of oxygen, the catalytic heater comprising a catalyst that facilitates combustion of the second flow of hydrogen and the flow of oxygen to produce heat;
wherein at least some of the heat produced by the combustion of the second flow of hydrogen and the flow of oxygen is transferred to the hydrogen storage material to desorb at least some of the desorbable hydrogen from the at least one hydridable material.

19. The system of claim 18, wherein the catalytic heater transfers heat indirectly to the hydrogen storage material by way of a heat transfer fluid that circulates between the catalytic heater and the hydrogen storage tank, the catalytic heater comprising a gas recuperator and a reactor, the gas recuperator comprising one or more heat transfer layers constructed and arranged to preheat the reactant gas mixture, the one or more heat transfer layers of the gas recuperator comprising an inlet-gas flow channel for communicating the reactant gas mixture and an outlet-gas flow channel for communicating combustion products from the reactor, the reactor comprising one or more heat transfer layers comprising the catalyst and being constructed and arranged to communicate and combust the reactant gas mixture and to further communicate the heat transfer fluid such that at least some of the heat is transferred to the heat transfer fluid, the one or more heat transfer layers of the reactor comprising a gas-flow channel for communicating and combusting the reactant gas mixture and a liquid-flow channel for communicating the heat transfer fluid, the gas-flow channel comprising fins that comprise the catalyst.

20. The system of claim 18, wherein the catalytic heater transfers heat directly to the hydrogen storage material, the catalytic heater being located within the hydrogen storage tank and in contact with or in close proximity to the hydrogen storage material, the catalytic heater comprising a gas distribution member and a catalyst-containing shell, the gas distribution member comprising perforated holes and the catalyst-containing shell comprising an inner surface that comprises the catalyst and an outer surface, the catalyst-containing shell accommodating the gas distribution member to form an annulus between the gas diffusion member and the inner surface of the catalyst-containing shell for communicating and combusting the reactant gas mixture such that at least some of the heat is transferred directly to the hydrogen storage material from the outer surface of the catalyst-containing shell.
